(19) United States
(12) Patent Application Publication
(10) Pub. No.: US 2012/0306869 A1
(43) Pub. Date: Dec. 6, 2012

(54) GAME DEVICE, IMAGE DISPLAY DEVICE, STEREOSCOPIC IMAGE DISPLAY METHOD AND COMPUTER-READABLE NON-VOLATILE INFORMATION RECORDING MEDIUM STORING PROGRAM

(75) Inventor: Ryo OZAKI, Minato-ku (JP)

(73) Assignee: Konami Digital Entertainment Co., Ltd., Tokyo (JP)

(21) Appl. No.: 13/488,755

(22) Filed: Jun. 5, 2012

(30) Foreign Application Priority Data
Jun. 6, 2011 (JP) 2011-126219

(51) Int. Cl. G06T 15/00

(52) U.S. Cl. 345/419

(57) ABSTRACT

The present disclosure provides a game device and/or the like that can adequately display a stereoscopic image that is easy to view. An acquirer specifies, for example, the object to collide with first on a line which extends from the current viewpoint in the line-of-sight direction, and acquires the depth position of that object. A setter sets the left and right virtual cameras arranged based on the current viewpoint. An image generator generates images photographed respectively from the left and right virtual cameras set. A synthesizer synthesizes a marker image in each game image based on the depth position of the object acquired by the acquirer. Then, a display controller controls the display of a stereoscopic image based on each game image in which the marker image is synthesized.

### CROSS-REFERENCE TO RELATED APPLICATION

This application claims the benefit of Japanese Patent Application No. 2011-126219, filed on Jun. 6, 2011, the entire disclosure of which is incorporated by reference herein.

### TECHNICAL FIELD

This application relates to a game device, an image display device, a stereoscopic image display method, and a computer-readable non-volatile information recording medium storing a program, whereby a stereoscopic image that is easy to view can be displayed adequately.

### BACKGROUND ART

Conventionally, game devices (video game devices and/or the like) which allow a player to play action games and so on have been widespread. In such action games, for example, the player operates a player character (a main character and/or the like), which carries weapons such as a gun and sword, to move freely in a virtual space (a game field and/or the like) and battle enemy characters and so on. That is to say, these action games focus on battles.

On the other hand, there are also infiltration-type action games, which do not focus on battles and in which a player character is controlled to move rather to avoid battles. In such infiltration-type action games, for example, a player character having infiltrated into the enemy base is controlled to hide and move so as to not be found by enemy characters and to accomplish predetermined missions.

In these action games, when targeting an enemy character with an armed gun and/or the like, a marker that serves as a sight (a target, and/or the like) is displayed. That is to say, the player is able to strike an enemy character with a bullet by shooting in a state in which the marker overlaps with the enemy character.

As an example of a game to display such a marker, an invention of a game device (video game device) that allows a locked-on target to be changed easily is disclosed (for example, see Unexamined Japanese Patent Application KOKAI Publication No. 2002-95868).

### SUMMARY

Recently, game devices that allow an image to be displayed in stereoscopy (3D stereoscopy) have been developed. By displaying game images of the above-described action games using such a game device that allows stereoscopy, there is an expectation to provide a game with an improved realistic sensation.

However, there is a problem in that, when the marker described above is displayed in an action game utilizing stereoscopy in the same way as conventionally done, it is difficult to view stereoscopic images.

That is to say, when arranging a marker that serves as a sight upon shooting, if the marker is arranged in a predetermined depth coordinate in the center of the screen in the same way as conventionally done, without taking into account the depth of an object to be targeted (a target object such as an enemy character, for example), cases might occur where a gap is produced between the target object and the marker in the depth direction. In this case, the focus on the target object and the focus on the marker are not the same, and this results in a disadvantage that, if the focus is placed on one of the target object and the marker, the other one looks blurred in double.

This disadvantage not only makes a stereoscopic image difficult to view, but also raises problems by, for example, making it not possible to shoot a point which the player aims at and making screen sickness more likely.

Given these backgrounds, there is a demand to develop a game device and/or the like which can display a stereoscopic image that is easy to view, even when a marker and/or the like that serves as a sight is displayed.

The present invention has been made in view of the foregoing, and it is therefore an object of the present invention to provide a game device, an image display device, a stereoscopic image display method, and a computer-readable non-volatile information recording medium storing a program, whereby a stereoscopic image that is easy to view can be displayed adequately.

The game device according to the first aspect of the present invention displays a game image to view various objects arranged in a three-dimensional virtual space from a viewpoint in the three-dimensional virtual space in a way to allow stereoscopy, and is configured to include an acquirer, a generator, a synthesizer and a display controller.

First, the acquirer acquires depth information of an object that is specified by operations by the player. For example, the acquirer specifies an object that is present in a direction which the player arbitrarily points or in the current line-of-sight direction, and acquires depth information of that object (for example, information that represents the absolute position or relative positional relationship of the depth with respect to the viewpoint). Also, the generator generates a plurality of game images based on the viewpoint. For example, a plurality of virtual cameras (for example, the left and right virtual cameras) arranged at both ends of a predetermined interval, from the viewpoint, are set, and a plurality of game images (for example, the left eye-use image and right eye-use image) photographed from the respective virtual cameras having been set are generated. Based on the acquired depth information of the object, the synthesizer synthesizes a marker image to represent a sight in each generated game image. Then, the display controller controls the display of a stereoscopic game image based on each game image in which the marker image has been synthesized. For example, the display controller controls the display of the stereoscopic game image utilizing binocular parallax and/or the like.

In the stereoscopic game image displayed in this way, the marker image looks as if to be located right in front of the specified object, and the depths of the marker image and the object are the same. Consequently, the focus is placed on both, and the disadvantage of blurred double vision does not occur.

Even when a marker image to serve as a sight is displayed, it is still possible to adequately display a stereoscopic image that is easy to view.

Only when the depth information of the object that is acquired by the acquirer is within a predetermined range of depth, the synthesizer may synthesize the marker image to represent a sight in each game image generated, based on the acquired depth information of the object.

In this case, in the event the specified object (the object which is specified and whose depth information is acquired by the acquirer) is present within the predetermined range of depth, the marker image to represent a sight is synthesized in each game image generated based on the acquired depth information of the object. On the other hand, in the event the specified object is present outside the predetermined range of depth, the marker image is synthesized based on different depth information from that of the specified object. For example, the marker image may be synthesized based on depth information of the frontmost part and/or the rearmost part of the predetermined range of depth, or the marker image may be synthesized in the frontmost part where the depth is always 0.

By employing this configuration, although, in the event a specified object is present in the predetermined range of depth, the depths of the specified object and the marker image are the same, so that the focus is placed on both, without blur, and it is possible to view both, still, in the event the specified object is present outside the predetermined range of depth, the depths of the specified object and the marker image are not the same, and therefore the focus is placed on only one, and blurred double vision may be produced.

That is to say, it is possible to report to the player whether or not the specified object is outside the predetermined range of depth, depending on whether or not the specified object and the marker image, when viewed, look blurred in double.

The above game device may further include a changer that changes the shape of the marker image, in the event depth information of the object acquired by the acquirer is outside the predetermined range of depth.

In this case, in the event the specified object is present outside the predetermined range of depth, the shape of the marker (marker image) changes. Consequently, given that the depths of the marker and the specified object are the same, the situation where the focus is not articulated and the view is unclear does not occur, and it is still possible to report to the player that the specified object is present outside the range of depth based on the change in the shape of the marker.

Note that, as for change in the shape of the object, the sight object may be enlarged or reduced depending on the distance to the specified object from the frontmost part and/or the rearmost part of the predetermined range of depth. For example, in the event the depth of the specified object is present before the predetermined range of depth, depending on the distance from the frontmost part of the range of depth to the depth of the specified object, the marker in an enlarged state may be arranged at the depth position of the specified object. By this means, the focus is placed on the marker and the specified object and the view is made clear, and, displaying enlarged marker allows the player to understand that the specified object should not be selected.

As for the range of depth, different ranges may be set depending on the characteristics of the character operated by the player or depending on what items that character possesses.

Here, the characteristics of the character refers to, for example, the ability points and experience points, which change through the advancement of games, and items refers to the types of weapons currently equipped (for example, a hand gun, a rifle, and so on).

By employing this configuration, different ranges of depth are set depending on, for example, the progression of the character and change of items, and consequently whether or not the specified object is within a range of depth also changes. Then, in the event the specified object is present in the range of depth, the specified object and the marker have the same depth and appear in focus. On the other hand, in the event the specified object is present outside the range of depth, the specified object and the marker do not have the same depth and therefore appears blurred and in double.

That is to say, it is possible to report whether or not a range of depth (shooting range, for example), which corresponds to the characteristics of the character and the items the character possesses, is effective for the specified object, based on the way the specified object and the marker appear.

The game device according to a second aspect of the present invention displays a game image to view various objects arranged in a three-dimensional virtual space from a viewpoint in the three-dimensional virtual space in a way to allow stereoscopy, and is configured to include an acquirer, an arranger, a generator and a display controller.

First, the acquirer acquires depth information of an object that is specified by operations by the player. For example, the acquirer specifies an object that is present in a direction which the player arbitrarily points or in the current line-of-sight direction, and acquires depth information of that object (for example, information that represents the absolute position or relative positional relationship of the depth with respect to the viewpoint). Also, the arranger arranges the marker object to represent a sight based on the acquired depth information of the object. Also, based on the viewpoint, the generator generates a plurality of game images, in which objects in the view, including the marker object, are arranged. For example, a plurality of virtual cameras (for example, the left and right virtual cameras) arranged at both ends of a predetermined interval, from the viewpoint, are set, and a plurality of game images (for example, the left eye-use image and right eye-use image) photographed from the respective virtual cameras having been set are generated. Then, the display controller controls the display of a stereoscopic game image based on each generated game image. For example, the display controller controls the display of the stereoscopic game image utilizing binocular parallax and/or the like.

In the stereoscopic game image displayed in this way, the marker object looks as if to be located right in front of the specified object, and the depths of the marker object and the object are the same. Consequently, the focus is placed on both, and the disadvantage of blurred double vision does not occur.

Even when a marker object to serve as a sight is displayed, it is still possible to adequately display a stereoscopic image that is easy to view.

Only when the depth information of the object that is acquired by the acquirer is within a predetermined range of depth, the arranger may synthesize the marker object to represent a sight, based on the acquired depth information of the object.

In this case, in the event the specified object is present in the predetermined range of depth, the marker object is arranged based on the acquired depth information of the object. On the other hand, in the event the specified object is present outside the predetermined range of depth, the marker object is arranged based on different depth information from that of the specified object. For example, the marker object may be arranged based on depth information of the frontmost part and/or the rearmost part of the predetermined range of depth, or the marker object may be arranged in the frontmost part where the depth is always 0.

By employing this configuration, although, in the event a specified object is present in the predetermined range of depth, the depths of the specified object and the marker object are the same, so that the focus is placed on both, without blur, and it is possible to view both, still, in the event the specified object is present outside the predetermined range of depth, the depths of the specified object and the marker object are not the same, and therefore the focus is placed on only one, and blurred double vision may be produced.

That is to say, it is possible for the player to understand whether or not the specified object is outside the predetermined range of depth, depending on whether or not the specified object and the marker object, when viewed, look blurred in double.

The above game device may further include a changer that changes the shape of the marker object, in the event depth information of the object acquired by the acquirer is outside the predetermined range of depth.

In this case, in the event the specified object is present outside the predetermined range of depth, the shape of the marker (marker object) changes. Consequently, given that the depths of the marker and the specified object are the same, the situation where the focus is not articulated and the view is unclear does not occur, and it is still possible for the player to understand that the specified object is present outside the range of depth based on change of the shape of the marker.

Note that, as for change of the shape of the object, the sight object may be enlarged or reduced depending on the distance to the specified object from the frontmost part and/or the rearmost part of the predetermined range of depth. For example, in the event the depth of the specified object is present before the predetermined range of depth, depending on the distance from the frontmost part of the range of depth to the depth of the specified object, the marker in an enlarged state may be arranged at the depth position of the specified object. By this means, the focus is placed on the marker and the specified object and the view is made clear, and, since displaying the enlarged marker allows the player to understand that the specified object should not be selected.

As for the range of depth, different ranges may be set depending on the characteristics of the character operated by the player or depending on what items that character possesses.

Here, the characteristics of the character refers to, for example, the ability points and experience points, which change during the advancement of games, and items refers to the types of weapons currently equipped (for example, a hand gun, a rifle, and so on).

By employing this configuration, different ranges of depth are set depending on, for example, the progression of the character and change of items, and consequently whether or not the specified object is within a range of depth also changes. Then, in the event the specified object is present within the range of depth, the specified object and the marker are at same depth and appear focused. On the other hand, in the event the specified object is present outside the range of depth, the specified object and the marker are not at the same depth and therefore appears blurred and in double.

That is to say, it is possible to indicate whether or not a range of depth (shooting range, for example), which corresponds to the characteristics of the character and the items the character has, is effective for the specified object, based on the way the specified object and the marker appear.

The image display device according to a third aspect of the present invention displays an image to view a three-dimensional virtual space in which objects are arranged from a predetermined viewpoint in a way to allow stereoscopy, and is configured to include an acquirer, a generator and a display controller.

First, the acquirer acquires depth information of an object (including, for example, objects such as a character object, icon and file) that is specified by operations by the player. For example, the acquirer specifies the object that is present in a direction which the player arbitrarily points or in the current line-of-sight direction, and acquires depth information of that object (for example, information that represents the absolute position or relative positional relationship of the depth with respect to the viewpoint). Also, based on the viewpoint, the generator generates a plurality of game images, in which a predetermined additional object (including, for example, a marker to represent a sight and a cursor represented by an arrow) is arranged, based on the depth information of the object acquired by the acquirer. For example, a plurality of virtual cameras (for example, the left and right virtual cameras) arranged at both ends of a predetermined interval, from the viewpoint, are set, and a plurality of game images (for example, the left eye-use image and right eye-use image) photographed from the respective virtual cameras having been set are generated. Then, the display controller controls the display of a stereoscopic image based on each generated image. For example, the display controller controls the display of the stereoscopic image utilizing binocular parallax and/or the like.

In the stereoscopic image displayed in this way, the additional object looks as if to be located right in front of the specified object, and the depths of the additional object and the object are the same. Consequently, the focus is placed on both, and the disadvantage of blurred double vision does not occur.

Even when a predetermined additional object is displayed, it is still possible to adequately display a stereoscopic image that is easy to view.

The stereoscopic image display method according to a fourth aspect of the present invention is the stereoscopic image display method in an image display device that includes an acquirer, a generator and a display controller, and that displays an image to view a three-dimensional virtual space in which objects are arranged from a predetermined viewpoint in a way to allow stereoscopy, and the stereoscopic image display method is configured to include an acquisition step, a generation step and a display control step.

First, in the acquisition step, depth information of an object that is specified by operations by the player is acquired. For example, in the acquisition step, an object that is present in a direction which the player arbitrarily points or in the current line-of-sight direction is specified, and depth information of that object (for example, information that represents the absolute position or relative positional relationship of the depth with respect to the viewpoint) is acquired. Also, in the generation step, based on the viewpoint, a plurality of game images, in which a predetermined additional object is arranged, are generated, based on the depth information of the object acquired in the acquisition step. For example, a plurality of virtual cameras (for example, the left and right virtual cameras) arranged at both ends of a predetermined interval, from the viewpoint, are set, and a plurality of game images (for example, the left eye-use image and right eye-use image) photographed from the respective virtual cameras having been set are generated. Then, in the display control step, the display of a stereoscopic image is controlled, based on each generated image. For example, in the display control step, the display of the stereoscopic image utilizing binocular parallax and/or the like is controlled.

In the stereoscopic image displayed in this way, the additional object looks as if to be located right in front of the specified object, and the depths of the additional object and the object are the same. Consequently, the focus is placed on both, and the disadvantage of blurred double vision does not occur.

Even when a predetermined additional object is displayed, it is still possible to adequately display a stereoscopic image that is easy to view.

The computer-readable non-transitory information recording medium storing a program, according to a fifth aspect of the present invention, is configured to allow a computer (including electronic devices) to function as the image display device described above.

This information recording medium stores a program on a non-transitory basis in a compact disk, a flexible disk, a hard disk, a magneto-optical disk, a digital-video disk, a magnetic tape, a semiconductor memory and/or the like. Then, the computer reads the program from the information recording medium and executes the program, and by this means can function as the above image display device.

The above program, apart from the computer on which this program is executed, can be distributed and sold via computer communication networks. Also, the above information recording medium can be distributed and sold separately from the above computer.

The present invention makes it possible to adequately display a stereoscopic image that is easy to view.

### BRIEF DESCRIPTION OF THE DRAWINGS

A more complete understanding of this application can be obtained when the following detailed description is considered in conjunction with the following drawings, in which:

FIG. 1 is a schematic view illustrating an outer appearance of an information processing device according to the present embodiment;

FIG. 2 is a block diagram illustrating a schematic configuration of an information processing device according to the present embodiment;

FIG. 3 is a block diagram for explaining the relationship between a first display and a parallax barrier;

FIG. 4 is a block diagram for explaining a configuration of a game device according to the first embodiment;

FIG. 5A is a plan view for explaining a state in which a line that extends from a viewpoint collides with an object.

FIG. 5B is a side view for explaining a state in which a line that extends from a viewpoint collides with an object.

FIG. 6A is a schematic view for explaining the arrangement of the left and right virtual cameras;

FIG. 6B is a schematic view for explaining the arrangement of the left and right virtual cameras;

FIG. 7A is a schematic view for explaining an image photographed by a virtual camera;

FIG. 7B is a schematic view for explaining an image photographed by a virtual camera;

FIG. 7C is a schematic view for explaining an image photographed by a virtual camera;

FIG. 7D is a schematic view for explaining an image photographed by a virtual camera;

FIG. 8A is a schematic view for explaining an overlaying process;

FIG. 8B is a schematic view for explaining an overlaying process;

FIG. 8C is a schematic view for explaining an overlaying process;

FIG. 8D is a schematic view for explaining an overlaying process;

FIG. 8E is a schematic view for explaining an overlaying process;

FIG. 9A is a schematic view illustrating an example of an image in which a marker image is synthesized;

FIG. 9B is a schematic view illustrating an example of an image in which a marker image is synthesized;

FIG. 10A is a schematic view illustrating an example of a stereoscopic image to be displayed;

FIG. 10B is a schematic view for explaining positional relationships in the depth direction of a stereoscopic image;

FIG. 11 is a flowchart for explaining a stereoscopic image display process according to the present embodiment;

FIG. 12 is a block diagram for explaining a configuration of a game device according to a second embodiment;

FIG. 13A is a schematic view for explaining the arrangement of a marker object;

FIG. 13B is a schematic view for explaining the arrangement of a marker object;

FIG. 14A is a schematic view for explaining the relationship between the shooting range and an object;

FIG. 14B is a schematic view for explaining the relationship between the shooting range and an object;

FIG. 15A is a schematic view for explaining the relationship between an object outside the shooting range and a marker image;

FIG. 15B is a schematic view for explaining the relationship between an object outside the shooting range and a marker image;

FIG. 15C is a schematic view for explaining the relationship between an object outside the shooting range and a marker image; and

FIG. 15D is a schematic view for explaining the relationship between an object outside the shooting range and a marker image.

### DETAILED DESCRIPTION

Now, embodiments of the present invention will be explained below. Although, for ease of understanding, embodiments will be described below in which the present invention is applied to a portable game device (game device), it is equally possible to apply the present invention to information processing devices such as various computers, PDAs, mobile telephones, and so on. That is to say, the embodiments which will be explained below are for illustrative purposes only, and by no means limit the scope of the present invention. Consequently, although a person skilled in the art should be able to employ embodiments which replace each or all of these elements with equivalents, such embodiments are also covered by the scope of the present invention.

### First Embodiment

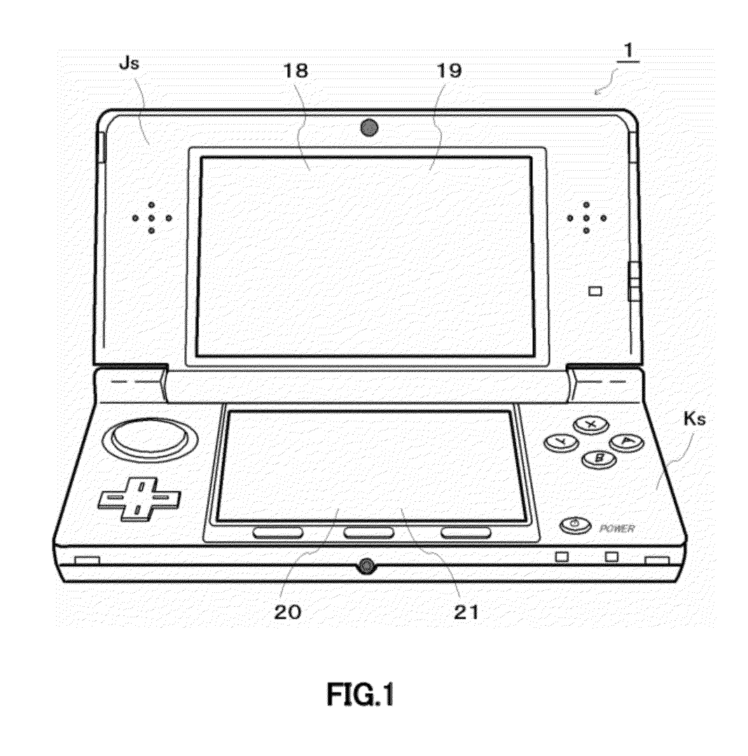

FIG. 1 is a view illustrating an example of an outer appearance of a typical information processing device 1 which realizes a game device according to an embodiment of the present invention. This information processing device 1 is, for example, a portable game device, and, as illustrated in the drawing, a first display 18 is provided in an upper housing Js and a second display 20 is provided in a lower housing Ks. Note that, as will be described later, a parallax barrier 19 is laid over the first display 18, so that it is possible to display an image in stereoscopy. Also, a touch panel 21 is laid over the second display 20.

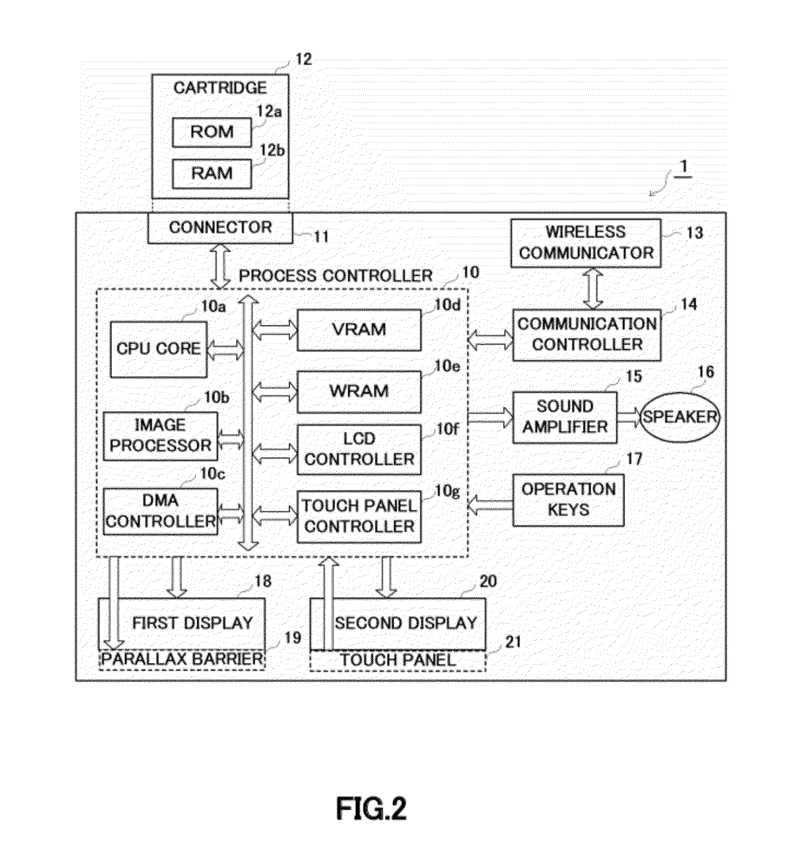

FIG. 2 is a block diagram illustrating a schematic configuration of this information processing device 1. Now, the information processing device 1 will be explained below with reference to this drawing. The information processing device 1 has a processing controller 10, a connector 11, a cartridge 12, a wireless communicator 13, a communication controller 14, a sound amplifier 15, a speaker 16, operation keys 17, a first display 18, a parallax barrier 19, a second display 20 and a touch panel 21.

The processing controller 10 has a CPU (Central Processing Unit) core 10a, an image processor 10b, a DMA (Direct Memory Address) controller 10c, a VRAM (Video Random Access Memory) 10d, a WRAM (Work RAM) 10e, an LCD (Liquid Crystal Display) controller 10f and a touch panel controller 10g.

The CPU core 10a controls the overall operations of the information processing device 1, and is connected with each component to exchange control signals and data. To be more specific, in a state in which the cartridge 12 is plugged in the connector 11, the CPU core 10a reads the programs and data stored in the ROM (Read Only Memory) 12a inside the cartridge 12 and executes predetermined processes.

The image processor 10b processes and modifies data read from the ROM 12a inside the cartridge 12 and data processed in the CPU core 10a. For example, the image processor 10b photographs a three-dimensional virtual space from a plurality of virtual cameras (the left and right virtual cameras, which will be described later), performs perspective transformation of the photographed images, and generates a plurality of images (the left eye-use image and right eye-use image, which will be described later).

The DMA controller 10c transfers the images generated in the image processor 10b to the VRAM 10d and/or the like. For example, the VRAM 10d stores the left eye-use image and right eye-use image generated in the image processor 10b, adequately.

The VRAM 10d is a memory to store information for display use, and stores image information modified in the image processor 10b and/or the like. For example, as will be described later, when a stereoscopic image is displayed on the first display 18, the left eye-use image and the right eye-use image, generated in the image processor 10b, are stored in the VRAM 10d alternately.

The WRAM 10e stores work data that is necessary when the CPU core 10a executes various processes according to programs.

The LCD controller 10f controls the first display 18 and the second display 20 to display certain display images. For example, the LCD controller 10f makes the first display 18 and second display 20 display images by converting image information stored in the VRAM 10d into display signals at predetermined synchronization timing. Note that, when displaying the stereoscopic image on the first display 18, as will be described later, the parallax barrier 19 is controlled such that the left eye-use image is seen by the player's left eye and the right eye-use image is seen by the right eye.

When a touch pen or the player's finger is pressed against the touch panel 21, the touch panel controller 10g acquires the coordinates of the pressed position (input coordinates).

The connector 11 is a terminal that can be detachably connected to the cartridge 12, and, when the cartridge 12 is connected, transmits and receives predetermined data to and from the cartridge 12.

The cartridge 12 has a ROM 12a and a RAM (Random Access Memory) 12b.

The ROM 12a stores programs for implementing games, and image data, sound data, and/or the like, that accompany the games.

The RAM 12b stores various data to show, for example, the status of progression of games.

The wireless communicator 13 is a unit to perform wireless communication with the wireless communicator 13 of another information processing device 1, and transmits and receives predetermined data via an un-illustrated antenna (built-in antenna and/or the like).

Note that the wireless communicator 13 is also able to perform wireless communication with a predetermined wireless access point. Also, the wireless communicator 13 is assigned a unique MAC (Media Access Control) address.

The communication controller 14 controls the wireless communicator 13, and, following predetermined protocols, intermediates the wireless communication that is performed between the processing controller 10 and the processing controller 10 of another information processing device 1.

Also, when the information processing device 1 connects to the Internet via a nearby wireless access point and/or the like, for example, the communication controller 14 intermediates the wireless communication performed between the processing controller 10 and the wireless access point and/or the like, following a protocol that complies with wireless LAN.

The sound amplifier 15 amplifies the sound signals generated in the processing controller 10, and supplies amplified signals to the speaker 16.

The speaker 16 includes, for example, a stereo speaker and/or the like, and outputs predetermined music sounds, sound effects and/or the like in accordance with the sound signals amplified in the sound amplifier 15.

The operation keys 17 are formed with various key switches and/or the like adequately arranged on the information processing device 1, and accepts predetermined command inputs in accordance with operations by the user.

The first display 18 and second display 20 are formed with LCDs and/or the like, controlled by the LCD controller 10f, and displays game images and/or the like adequately. Note that the first display 18 is able to display the stereoscopic image by means of the parallax barrier 19 and/or the like.

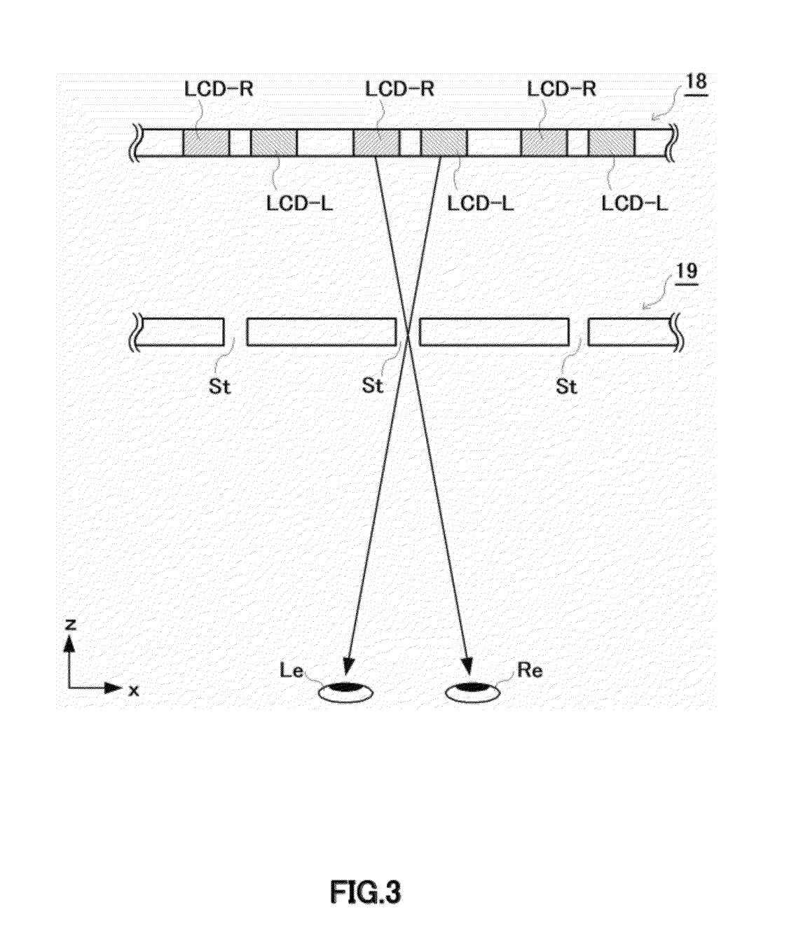

The parallax barrier 19 is formed with, for example, a filter and/or the like that can electrically control light beams to be blocked and transmitted, and, as illustrated in FIG. 3, arranged in front of the first display 18. For example, slits St are formed along vertical rows, in the parallax barrier 19. Then, when displaying the stereoscopic image on the first display 18, light beams from different pixels enter the player's left eye Le and the right eye Re via the slits St. That is to say, when the parallax barrier 19 is controlled to be effective (ON), light beams other than that via the slits St are blocked. On the other hand, in the first display 18, left eye-use pixels LCD-L and right eye-use pixels LCD-R are arranged alternately per vertical row, for example. Consequently, by means of the parallax barrier 19, light beams from the left eye-use pixels LCD-L are radiated on the left eye Le, and, also, light beams from the right eye-use pixels LCD-R are radiated on the right eye Re.

Note that, when displaying a normal flat image, the parallax barrier 19 is controlled to be ineffective (OFF), and allows light beams other than that via the slits St to transmit. Consequently, light beams form the same pixels enter both the left eye Le and the right eye Re.

Referring back to FIG. 2, the touch panel 21 is laid over the second display 20, and detects inputs from the touch pen, the player's finger and/or the like.

For example, the touch panel 21 is formed with a touch sensor panel of a resistive film manner, detects the press (depression) by the player's finger, the touch pen and/or the like, and outputs information (signals and/or the like) corresponding to the coordinates of the pressed position.

### Summary of Game Device

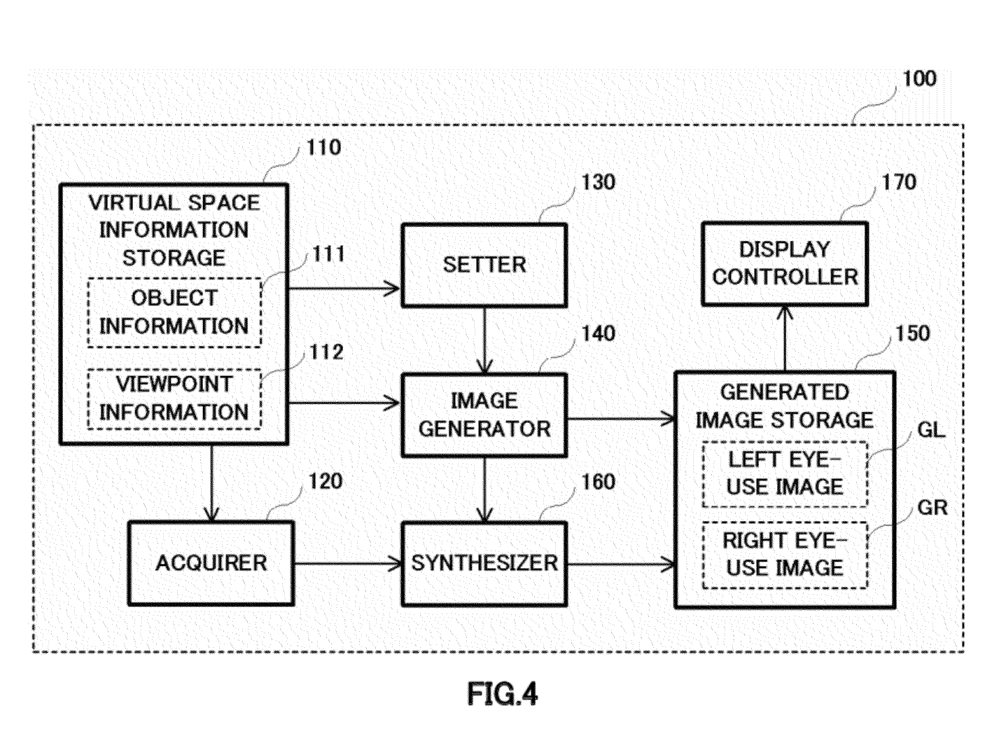

FIG. 4 is a block diagram illustrating a schematic configuration of the game device 100 according to the first embodiment of the present invention. This game device 100 displays a game image which views from an arbitrary viewpoint (the viewpoint which the player can operate) various objects (player characters, enemy characters, etc.) arranged in a three-dimensional virtual space, in a way to allow stereoscopy. Now, the game device 100 will be explained below with reference to this drawing.

As illustrated in FIG. 4, the game device 100 has a virtual space information storage 110, an acquirer 120, a setter 130, an image generator 140, a generated image storage 150, a synthesizer 160 and a display controller 170.

Note that, as will be described later, it is possible to group the setter 130 and image generator 140 together to function as one generator.

First, the virtual space information storage 110 stores, for example, object information 111 and viewpoint information 112.

The object information 111 is information about various objects (player characters, enemy characters, etc.) arranged in the three-dimensional virtual space. For example, the object information 111 includes graphic information such as polygons and textures, and position information such as the current position and orientation.

The position information (the current position and orientation) in this object information 111 can be changed as appropriate. For example, the player character's position information is changed as appropriate according to operations by the player. Also, position information of enemy characters is changed as appropriate based on predetermined logic and/or the like.

The viewpoint information 112 is information about the viewpoint to serve as the basis when viewing (photographing) the three-dimensional virtual space, and includes, for example, information about the current position, the line-of-sight direction, and/or the like. The position and direction of this viewpoint information 112 can be changed according to operations by the player, for example.

Note that the above-described ROM 12a and WRAM 10e might function as this virtual space information storage 110.

The acquirer 120 specifies an object based on operations by the player, and acquires depth information of the specified object. For example, with reference to the above-described viewpoint information 112, which is changed according to operations by the player, the object to collide with first on the line which extends from the current viewpoint to the line-of-sight direction is specified.

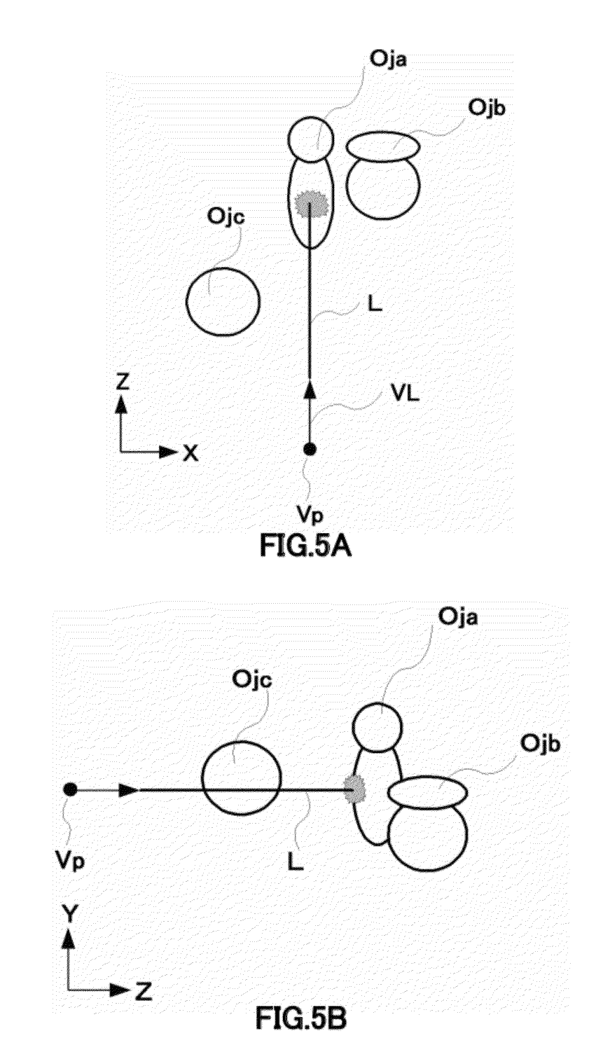

To be more specific, as illustrated in the plan view of FIG. 5A and the side view of FIG. 5B, the acquirer 120 first specifies an object Oja, which a line L to extend from a viewpoint Vp in a line-of-sight direction VL collides with (reaches) first. This collision detection is made not only when the line L collides with the object Oja itself, and, besides, may be made to specify that object Oja when the line L collides with the bounding box (collision detection area) defined for the object Oja.

Then, the acquirer 120 acquires depth information of the specified object. This depth information is, for example, information to represent the absolute position or relativize positional relationship of the depth with respect to the viewpoint. In the following, depth information will be described as a depth position (Z position, for example) for ease of understanding.

Also, when the background part or the back clip plane is arrived at without collision with objects, depth information of that background part and/or the like is acquired.

Note that the above-described CPU core 10a and image processor 10b might function as this acquirer 120.

Referring back to FIG. 4, the setter 130 sets a plurality of virtual cameras that are arranged based on the current viewpoint, with reference to the above-described viewpoint information 112.

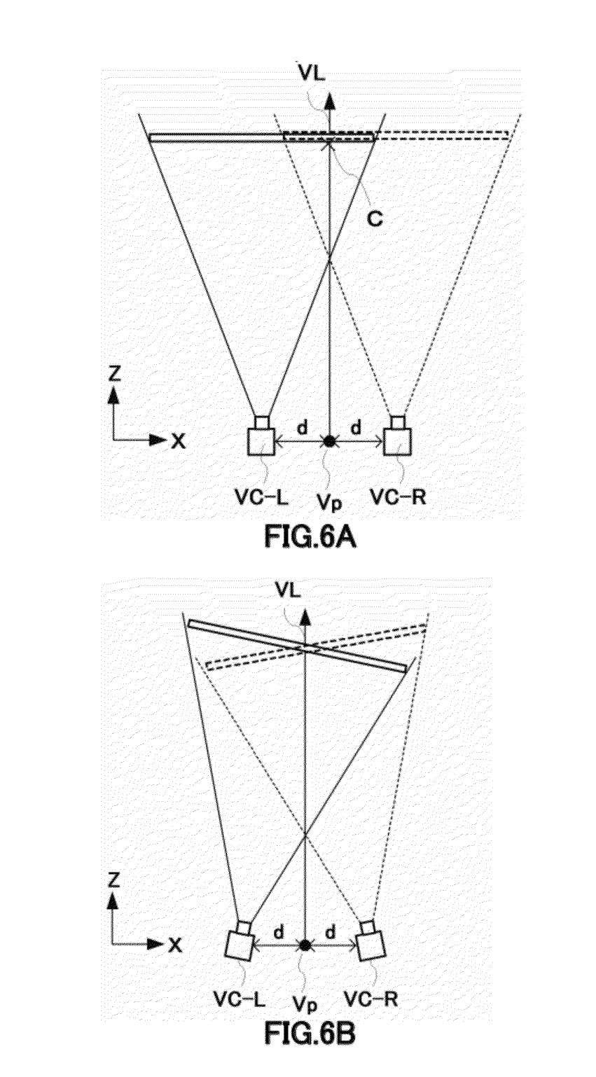

For example, as illustrated in the plan view of FIG. 6A, the setter 130 sets the left virtual camera VC-L and the right virtual camera VC-R in parallel (that is, the orientations of those cameras are along the orientation of the line of sight VL), at both ends which are a predetermined distance d apart in the horizontal direction (X direction), based on the viewpoint Vp. In this case, in images photographed by the left virtual camera VC-L and the right virtual camera VC-R, the position of the true center point C (the point to cross the line of sight VL) is not the center of each image. Consequently, for images photographed and generated from the left and right virtual cameras VC-L and VC-R, an overlaying process is performed as will be described later.

Also, the arrangement of virtual cameras is not limited to the parallel arrangement illustrated in FIG. 6A, and other methods of arrangement are equally possible. For example, as illustrated in the plan view of FIG. 6B, the setter 130 may arrange the left virtual camera VC-L and the right virtual camera VC-R to face each other at a predetermined angle (angle of vergence), at both ends which are a predetermined distance d apart in the horizontal direction, based on the viewpoint Vp. In this case, in images photographed by the left virtual camera VC-L and the right virtual camera VC-R, the center point crosses the line of sight VL. Consequently, although the overlaying process such as the one described later is unnecessary, cases might occur where the parallax increases too much with respect to images (objects) in the distant view. Consequently, correction might be applied as adequate to images in the distant view.

A case will be described with the following explanation where the setter 130 arranges the left and right virtual cameras VC-L and VC-R in parallel as illustrated in FIG. 6A.

Note that the above-described CPU core 10a and image processor 10b might function as this setter 130.

Referring back to FIG. 4, the image generator 140 generates a plurality of game images photographed respectively by the virtual cameras that are set.

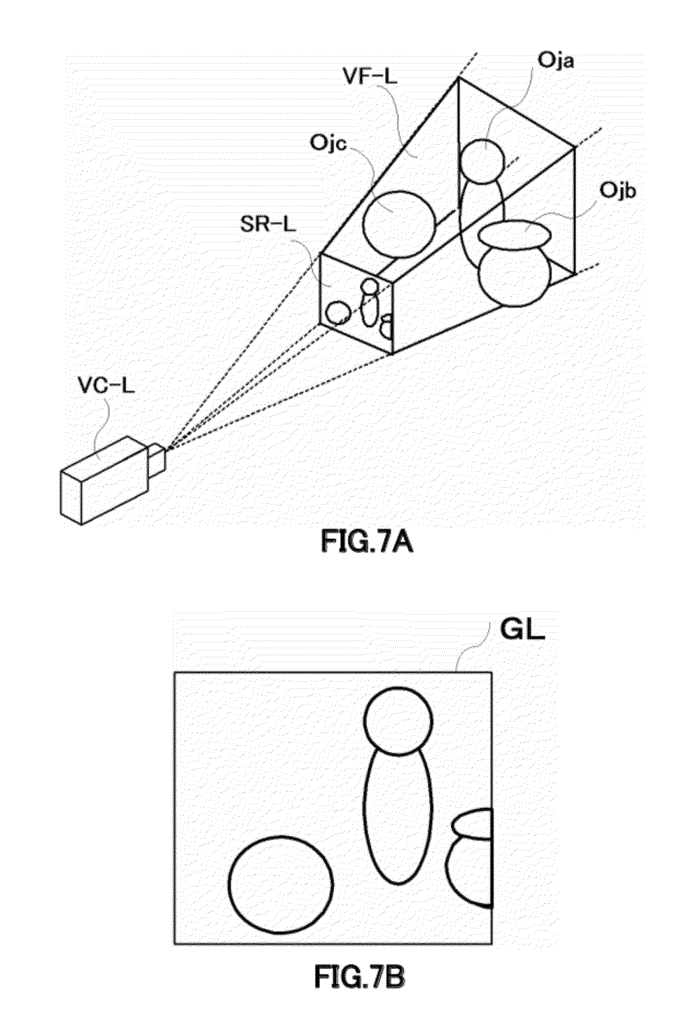

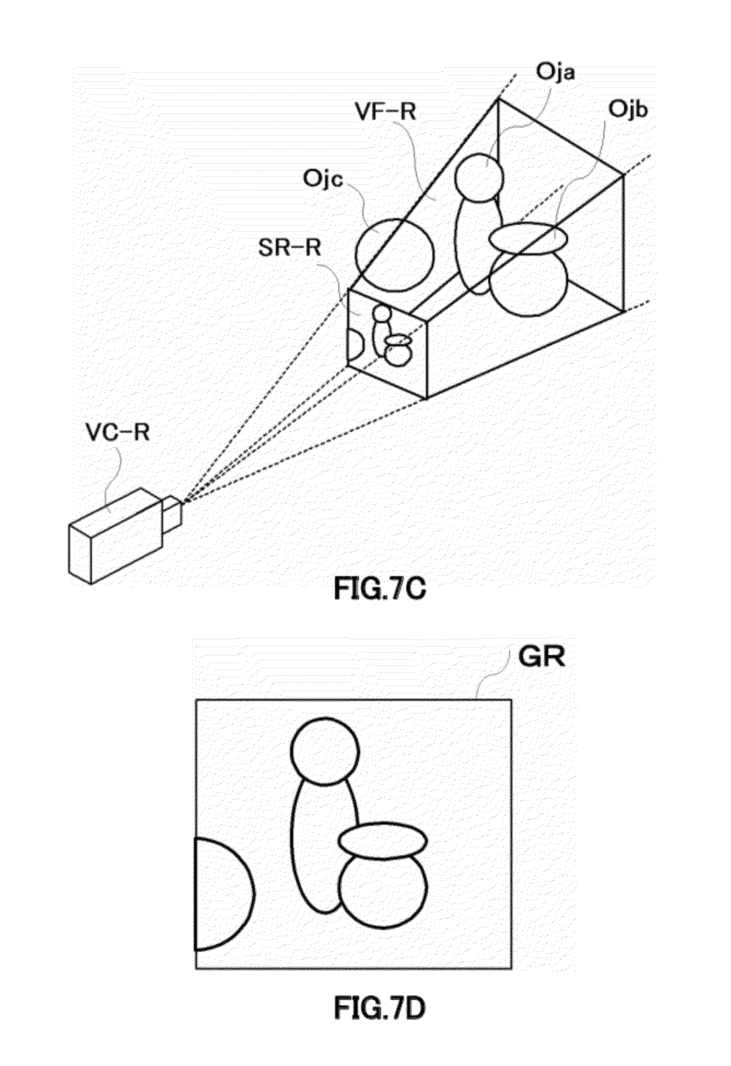

For example, the image generator 140 references the above-described object information 111, and, as illustrated in FIG. 7A, generates an image in which objects Oja to Ojc, located in the view frustum VF-L of the left virtual camera VC-L, are perspective-transformed (i.e. perspective projection transformation) onto a projection plane SR-L. That is to say, a left eye-use image GL such as the one illustrated in FIG. 7B is generated.

Likewise, as illustrated in FIG. 7C, the image generator 140 generates an image in which object Oja to Ojc, located in the view frustum VF-R of the right virtual camera VC-R, are perspective-transformed onto a projection plane SR-R. That is to say, a right eye-use image GR such as the one illustrated in FIG. 7D is generated.

Then, the image generator 140 performs the overlaying process with respect to the generated left eye-use image GL and right eye-use image GR. That is to say, as explained earlier with the above-described FIG. 6A, in the images photographed respectively by the left virtual camera VC-L and right virtual camera VC-R, the center of each image is not in the position of the true center point C. Consequently, the overlaying process is performed to allow the center position in each image to be the same as the position of the true center point C.

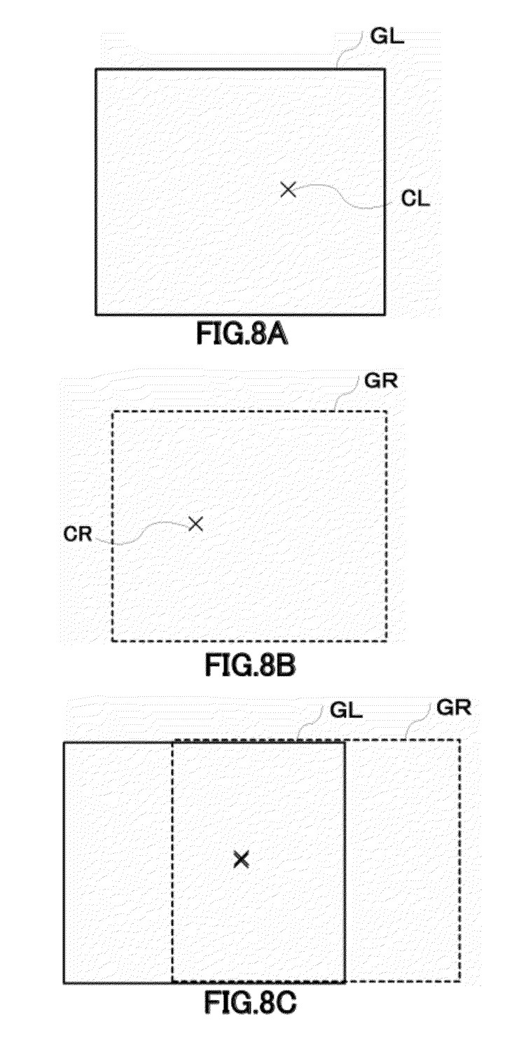

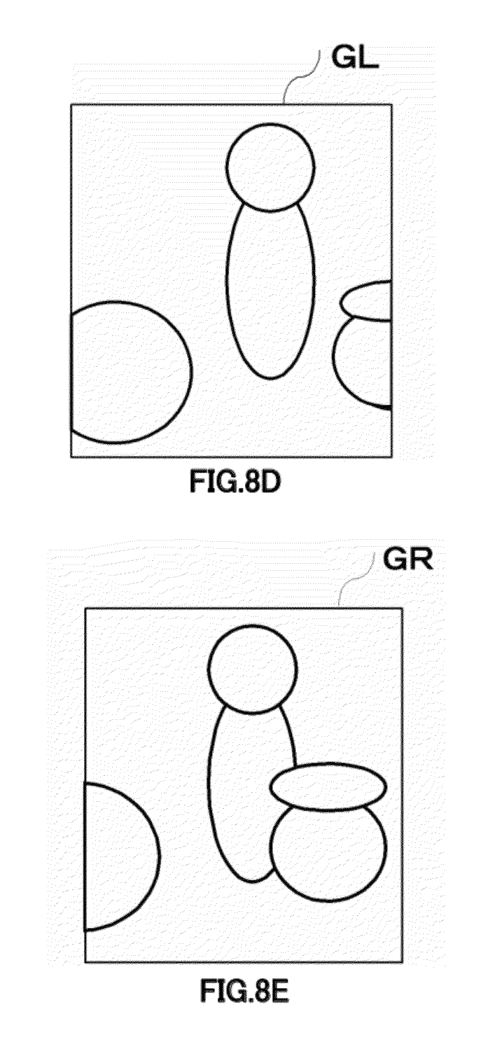

To be more specific, the overlaying process is performed as illustrated in FIG. 8C, so as to allow the true center point CL in the left eye-use image GL illustrated in FIG. 8A and the true center point CR in the right eye-use image GR illustrated in FIG. 8B align.

When this takes place, outer areas that are unnecessary from the relationship of parallax are removed, and, finally, the image generator 140 generates the left eye-use image GL illustrated in FIG. 8D and the right eye-use image GR illustrated in FIG. 8E.

Note that the above-described image processor 10b might function as this image generator 140.

Now, although the setter 130 and image generator 140 have been described above separately with this embodiment for ease of understanding of the invention, the setter 130 and image generator 140 may be grouped to function as one generator.

Referring back to FIG. 4, the generated image storage 150 stores the game images generated by the image generator 140. That is to say, the generated image storage 150 stores the left eye-use image GL illustrated in the FIG. 8D and the right eye-use image GR illustrated in FIG. 8E, described above.

Note that the above-described VRAM 10d and/or the like might function as this generated image storage 150.

Based on the depth position of the object acquired by the acquirer 120, the synthesizer 160 synthesizes a marker image representing a sight, at a position corresponding to the parallax of each game image.

For example, as illustrated in the above-described FIGS. 5A and 5B, in the event the acquirer 120 has acquired the depth position of the object Oja, the synthesizer 160 obtains, based on this depth position, positions corresponding the parallax in the left eye-use image GL of FIG. 8D and the right eye-use image GR of FIG. 8E described above.

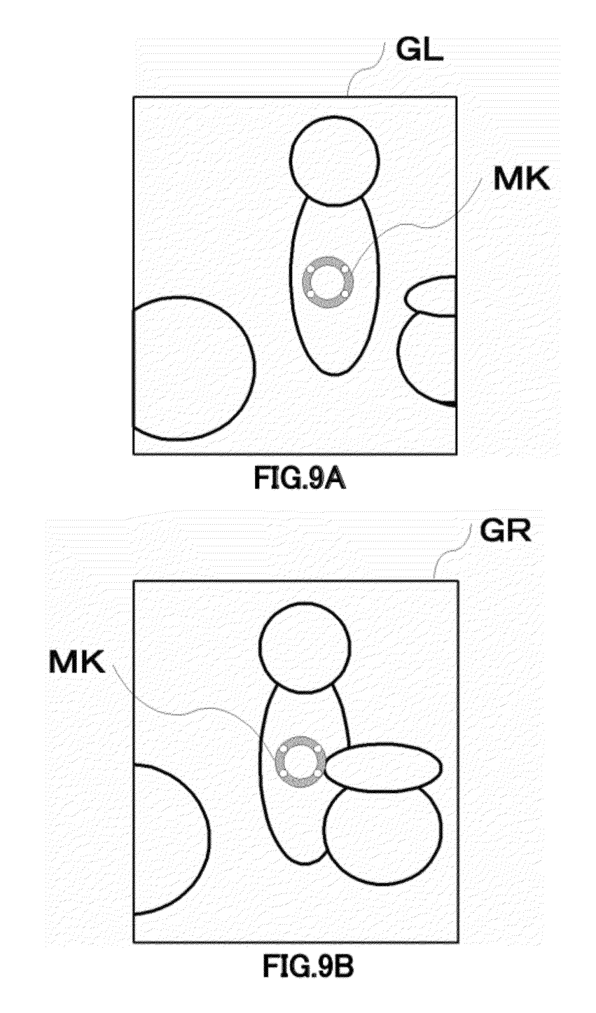

Then, as illustrated in FIGS. 9A and 9B, the synthesizer 160 synthesizes the marker image MK in each position. That is to say, the synthesizer 160 overwrites the marker image MK in the left eye-use image GL and the right eye-use image GR stored in the generated image storage 150. This marker image MK is an example and may be given in other shapes and/or the like.

Note that the above-described image processor 10b might function as this synthesizer 160.

Referring back to FIG. 4, the display controller 170 controls display of stereoscopic game images utilizing binocular parallax based on the game images in which marker images are synthesized.

That is to say, the display controller 170 controls the left eye-use image GL illustrated in FIG. 9A to be seen only by the player's left eye, and also controls the right eye-use image GR illustrated in FIG. 9B to be seen only by the player's right eye.

To be more specific, the display controller 170 associates the left eye-use image GL with the left eye-use pixels LCD-L of the first display 18 illustrated in FIG. 3, and also associates the right eye-use image GR with the right eye-use pixels LCD-R of the first display 18, and displays these images. When this takes place, by controlling the parallax barrier 19 effective, only light beams from the left eye-use pixels LCD-L are radiated on the player's left eye Le and only light beams from the right eye-use pixels LCD-R are radiated on the right eye Re.

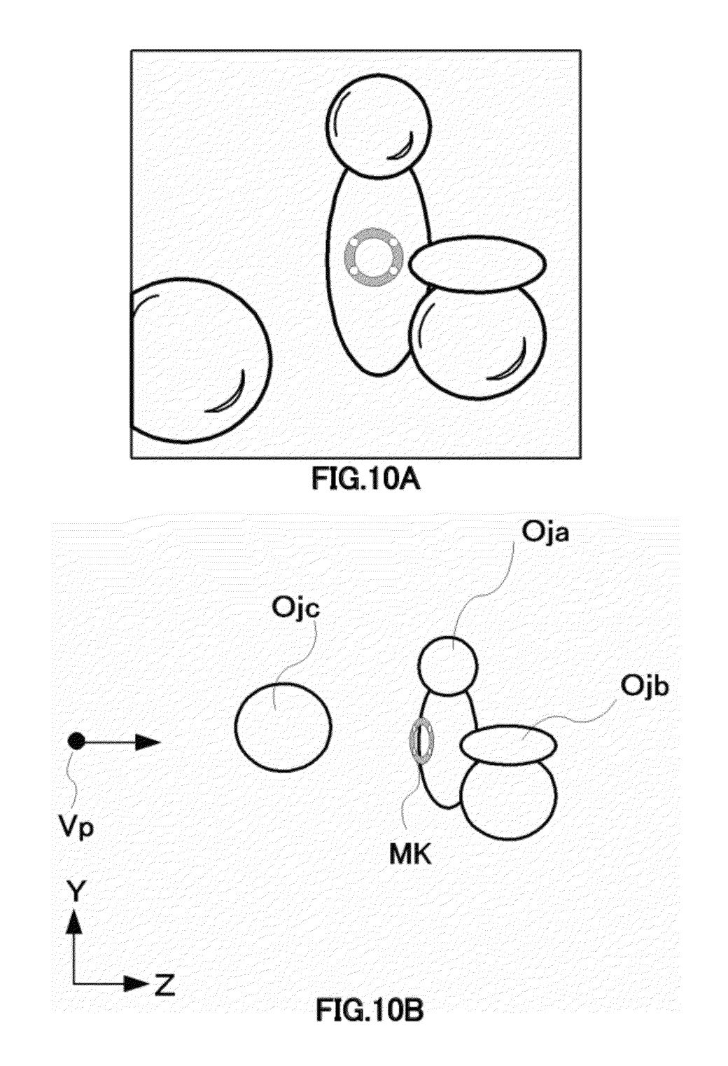

By this means, an image such as the one illustrated in FIG. 10A is displayed in stereoscopy. When this takes place, as illustrated in FIG. 10B, to the player, the marker image MK looks as if to be located right in front of the target object Oja. That is to say, the depths of the marker image MK and the object Oja (that is, the positions of the two in the depth direction) are the same, so that, regardless of on which one the focus is placed, the disadvantage where the other looks blurred in double does not occur.

Note that the above-described LCD controller 10f and parallax barrier 19 and/or the like might function as this display controller 170.

### Summary of Operation of Game Device

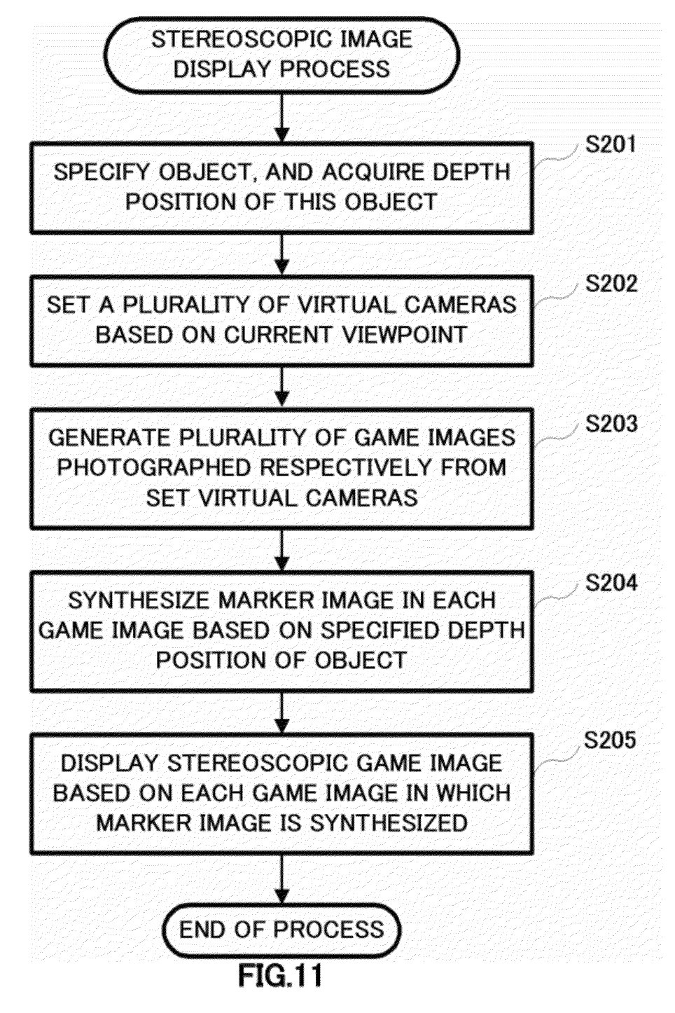

Now, the operations of the game device 100 with such configuration will be explained below with reference to the accompanying drawings. As an example, the operations of the game device 100 in an action game will be explained with reference to FIG. 11. FIG. 11 is a flowchart illustrating the flow of a stereoscopic image generation process. This stereoscopic image generation process repeats being executed every predetermined drawing cycle (for example, every 1/60 second) while a game is in progress.

First, the game device 100 specifies an object and acquires the depth position of that object (step S201).

That is to say, the acquirer 120 references viewpoint information 112 stored in the virtual space information storage 110 and specifies the object to collide with first on the line which extends from the current viewpoint to the line-of-sight direction. For example, as illustrated in FIGS. 5A and 5B described above, the acquirer 120 specifies the object Oja, which the line L to extend from the viewpoint Vp collides with (reaches) first. Then, the acquirer 120 acquires the depth position of the specified object Oja.

The game device 100 sets a plurality of virtual cameras based on the current viewpoint (step S202).

That is to say, the setter 130 references the viewpoint information 112 and sets the left and right virtual cameras arranged based on the current viewpoint. For example, as illustrated in FIG. 6A described above, the setter 130 sets the left virtual camera VC-L and the right virtual camera VC-R in parallel, at both ends which are the predetermined distance d apart in the horizontal direction, based on the viewpoint Vp.

The game device 100 generates a plurality of game images photographed by the set virtual cameras respectively (step S203).

That is to say, the image generator 140 references object information 111 stored in the virtual space information storage 110, and generates images photographed by the left and right virtual cameras set by the setter 130. For example, the image generator 140 generates left eye-use image GL illustrated in FIG. 7B photographed (subjected to perspective projection transformation) from the left virtual camera VC-L illustrated in FIG. 7A. Likewise, the image generator 140 generates right eye-use image GR illustrated in FIG. 7C photographed from the right virtual camera VC-R illustrated in FIG. 7B.

Also, the image generator 140 performs the overlaying process illustrated in FIG. 8C described above, with respect to the left eye-use image GL and right eye-use image GR generated, and, finally, generates the left eye-use image GL illustrated in FIG. 8D and the right eye-use image GR illustrated in FIG. 8E.

The game device 100 synthesizes the marker image in each game image based on the depth position of the object acquired in step S201 (step S204).

That is to say, based on the depth position acquired by the acquirer 120, the synthesizer 160 synthesizes the marker image in positions corresponding to the parallax in the left eye-use image GL and the right eye-use image GR. For example, based on the acquired depth position of the object Oja, as illustrated in FIGS. 9A and 9B described above, the synthesizer 160 synthesizes the marker image MK to represent a sight in positions corresponding to the parallax in the left eye-use image GL and the right eye-use image GR.

Then, the game device 100 generates a stereoscopic game image based on each game image in which the marker image is synthesized (step S205).

That is to say, the display controller 170 controls the left eye-use image GL illustrated in FIG. 9A to be seen only by the player's left eye, and also controls the right eye-use image GR illustrated in FIG. 9B to be seen only by the player's right eye. To be more specific, the display controller 170 associates the left eye-use image GL with the left eye-use pixels LCD-L of the first display 18 illustrated in FIG. 3, and also associates the right eye-use image GR with the right eye-use pixels LCD-R of the first display 18, and displays these images. When this takes place, by controlling the parallax barrier 19 effectively, only light beams from the left eye-use pixels LCD-L are radiated on the player's left eye Le and only light beams from the right eye-use pixels LCD-R are radiated on the right eye Re.

By means of this stereoscopic image generation process of FIG. 11, the image illustrated in FIG. 10A described above is displayed in stereoscopy. When this takes place, to the player, as illustrated in FIG. 10B described above, the marker image MK looks as if to be located right in front of the target object Oja, and the depths of the marker image MK and the object Oja match. Consequently, the focus is placed on both, and the disadvantage of blurred double vision does not occur.

Even when the marker image to serve as a sight is displayed, it is still possible to display the stereoscopic image that is easy to view.

### Second Embodiment

A case has been described above with the first embodiment where, after each game image (the left eye-use image GL and the right eye-use image GR) is generated, and the synthesizer 160 synthesizes (overwrites) the marker image MK therein. However, instead of performing such synthesis, it is equally possibly to generate each game image in a state in which a marker object to represent a sight is arranged as adequate in a three-dimensional virtual space.

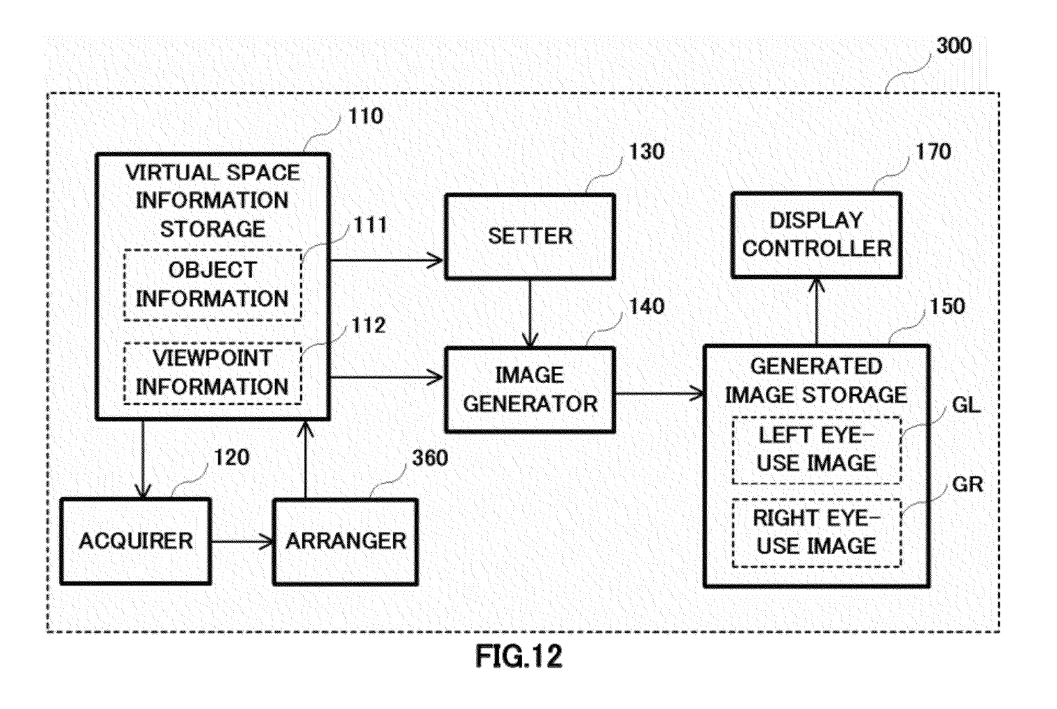

Now, a game device 300 which has a feature of arranging a marker object in a three-dimensional virtual space as adequate will be explained with reference to FIG. 12. FIG. 12 is a block diagram illustrating a schematic configuration of the game device 300 according to a second embodiment.

As illustrated in FIG. 12, the game device 300 has a virtual space information storage 110, an acquirer 120, a setter 130, an image generator 140, a generated image storage 150, an arranger 360 and a display controller 170.

That is to say, the arranger 360 is provided instead of the synthesizer 160 of the above-described game device 100. Note that the configurations of the virtual space information storage 110 through the generated image storage 150 and the display controller 170 are substantially the same as the corresponding configurations in the game device 100 described above.

That is to say, in the same way as described above, the acquirer 120 references the viewpoint information 112 and specifies the object to collide with first on the line which extends from the current viewpoint to the line-of-sight direction. Then, the acquirer 120 acquires the depth position of the specified object.

Also, the setter 130 sets a plurality of virtual cameras that are arranged based on the current viewpoint, with reference to the viewpoint information 112 as described above.

Based on the depth position of the object acquired by the acquirer 120, the arranger 360 arranges the marker object to represent a sight in a position to be right in front of that object.

That is to say, the object information 111 includes information about the marker object, and the arranger 360 sets position information of the marker object in a depth position to be right in front of that object, based on the acquired depth position.

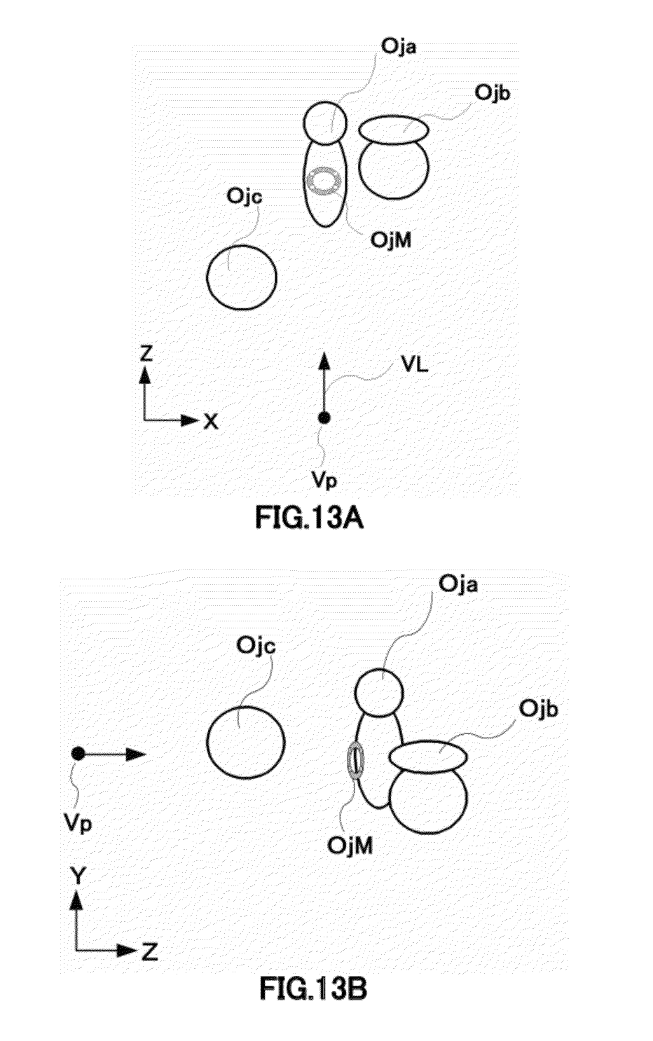

To be more specific, as illustrated in the plan view of FIG. 13A and the side view of FIG. 13B, when the depth position of an object Oja is acquired, a marker object OjM is arranged in a position in front of that object Oja.

Also, the image generator 140 likewise generates a plurality of game images photographed respectively from the virtual cameras set by the setter 120. That is to say, images in which objects including the marker object arranged by the above-described arranger 360 (that is, objects in the view frustum) are photographed from the left and right virtual cameras, are generated.

When this takes place, for example, the image generator 140 makes the Z value of the marker object in a Z buffer the minimum value, so that the marker object is not hidden by other objects (that is, placed frontmost).

Finally, after performing the overlaying process and/or the like likewise, the image generator 140 generates the left eye-use image GL and the right eye-use image GR including the marker object.

Then, the display controller 170 controls the display of a stereoscopic game image utilizing binocular parallax based on each game image.

To be more specific, the display controller 170 associates the left eye-use image GL with the left eye-use pixels LCD-L of the first display 18 illustrated in FIG. 3, and also associates the right eye-use image GR with the right eye-use pixels LCD-R of the first display 18, and displays these images. When this takes place, by controlling the parallax barrier 19 effective, only light beams from the left eye-use pixels LCD-L are radiated on the player's left eye Le and only light beams from the right eye-use pixels LCD-R are radiated on the right eye Re.

By this means, an image such as the one illustrated in FIG. 10A is displayed in stereoscopy. When this takes place, as illustrated in FIG. 10B, to the player, the marker image MK (marker object, in this case) looks as if to be located right in front of the target object Oja. That is to say, since the depths of the marker image MK and the object Oja match, regardless of on which one the focus is placed, the disadvantage where the other one looks blurred in double does not occur.

Even when the marker object to serve as a sight is displayed, it is still possible to display the stereoscopic image that is easy to view.

### Variations

Cases have been described above with the first and second embodiments where a stereoscopic image which, regardless of in which position in a three dimensional space the depth position of a specified object is, the appearance is such that a marker image (marker object) is arranged in front of a specified object. However, to improve the gaming aspect, it is equally possible to change the depth position of the marker image as appropriate depending on whether or not a specified object is present within a predetermined range of depth, which is, for example, a range of depth associated with the weapon currently equipped by a player character (for example, a shooting range or striking distance).

Now, variations of game devices 100 and 300 having a feature of arranging a marker image as appropriate in accordance with the shooting range of weapons will be described.

First, the game device 100 will be explained.

Note that prescriptive information related to each weapon is added to object information 111. This prescriptive information prescribes information about, for example, the shooting range (striking distance) and hit probability of each weapon which the player character can equip.

Then, whether or not the depth position of an object acquired by the acquirer 120 is within the prescribed shooting range is determined, and, in the event the object is within the shooting range, the synthesizer 160 synthesizes the marker image on each game image based on the depth position of that object. On the other hand, in the event the object is not within the shooting range, the synthesizer 160 synthesizes the marker image on each game image based on a different position from the depth position of that object, which is, for example, the position of the frontmost part or rearmost part of the shooting range.

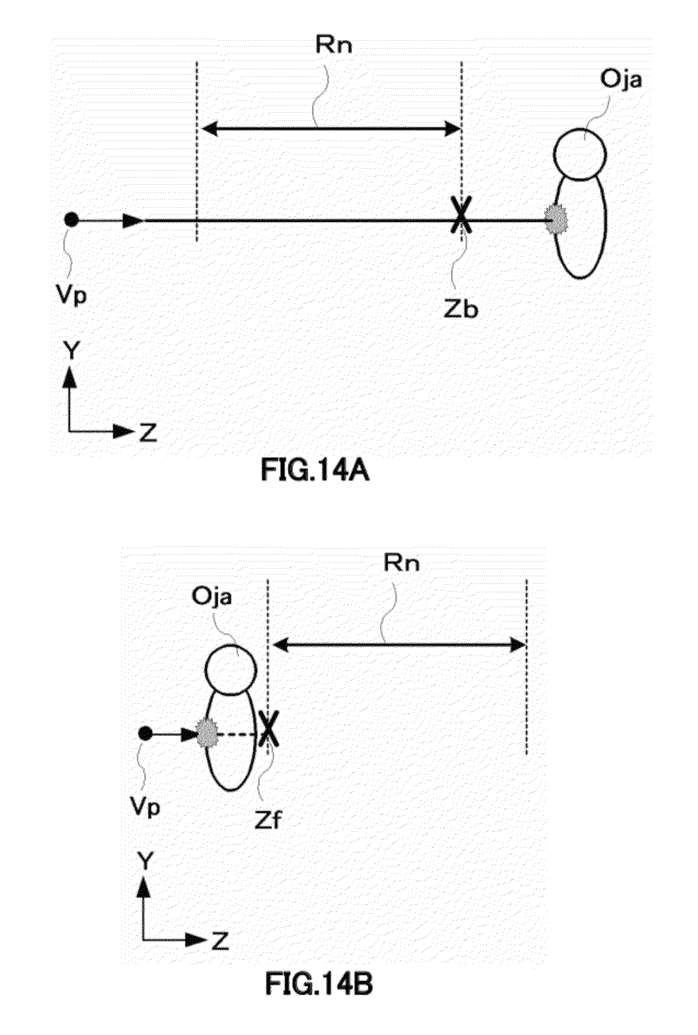

To be more specific, as illustrated in FIG. 14A, in the event the depth position of the specified object Oja is far beyond a shooting range Rn, the synthesizer 160 obtains positions corresponding to the parallax in the left eye-use image GL and right eye-use image GR, based on a depth position Zb of the rearmost part of the shooting range Rn, and synthesizes the marker image in each position.

On the other hand, as illustrated in FIG. 14B, in the event the depth position of the specified object Oja exist at the near side of the shooting range Rn (i.e. too close to the player), the synthesizer 160 obtains positions corresponding to the parallax in left eye-use image GL and right eye-use image GR based on a depth position Zf of the frontmost part of the shooting range Rn, and synthesizes the marker image in each position. When this takes place, the synthesizer 160 enlarges the marker image based on the difference between the depth position of the object Oja and the depth position Zf. That is to say, the synthesizer 160 functions as a changer and changes the shape of the marker image.

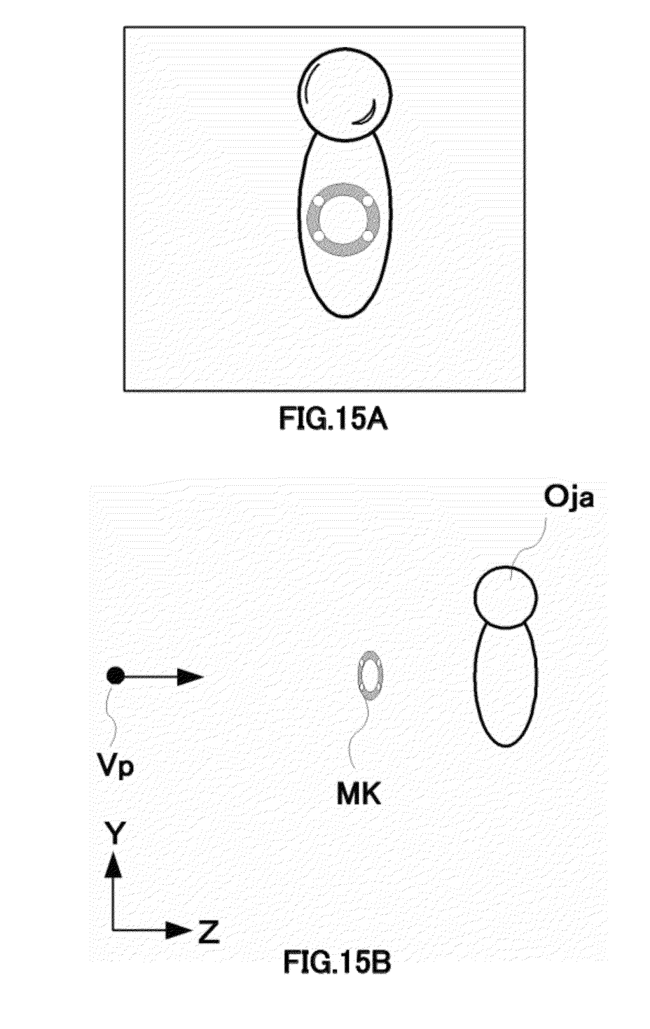

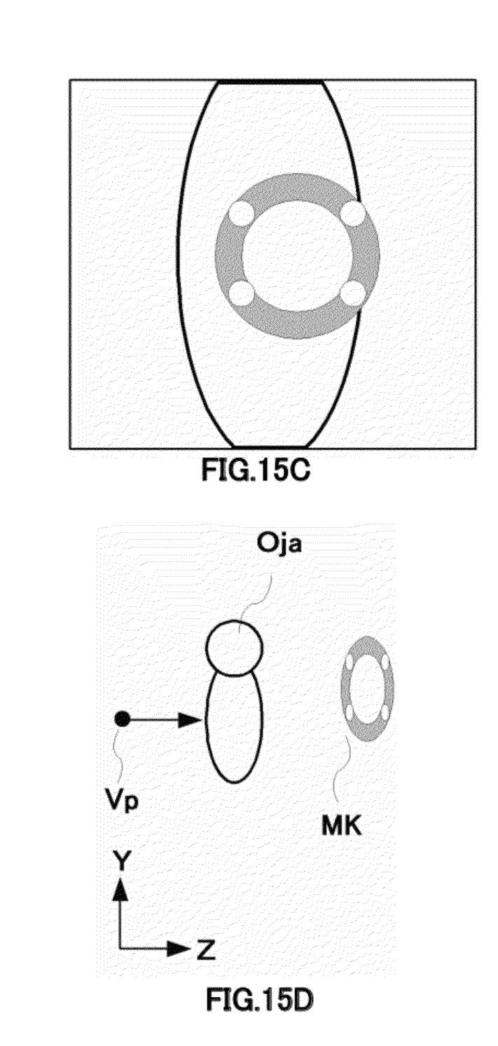

Then, the display controller 170 controls the display of stereoscopic game images illustrated in FIG. 15A, 15C based on these game images and marker image.

That is to say, in the event the depth position of the object Oja is far beyond the shooting range Rn, the display controller 170 controls the display of the stereoscopic game image illustrated in FIG. 15A. When this takes place, as illustrated in FIG. 15B, to the player, the marker image MK looks as if to be located significantly closer to the player than the target object Oja. That is to say, since a gap in depth is produced between the marker image MK and the object Oja, a situation where arranging the focus on one makes the other one look blurred in double, is intentionally created. By means of this display, it is possible to let the player know that the object Oja is present outside the shooting range (far beyond the shooting range) of the weapon equipped.

On the other hand, in the event the depth position of the object Oja does not represents near side of the shooting range Rn, the display controller 170 controls the display of the stereoscopic game image illustrated in FIG. 15C. When this takes place, as illustrated in FIG. 15D, to the player, the marker image MK appears enlarged behind the target object Oja. In this case, also, a gap is produced between the positions of the marker image MK and the object Oja in the depth direction, a situation where arranging the focus on one makes the other one look blurred in double, is intentionally created. Furthermore, since the marker image MK is enlarged, it is possible to let the player know that the object Oja is outside the shooting range (near side of the shooting range) of the weapon equipped.

Next, the game device 300 will be explained.

Likewise, prescriptive information (including the shooting range) related to each weapon is added to object information 111.

Then, whether or not the depth position of the object acquired by the acquirer 120 is within the prescribed shooting range is determined, and, in the event the object is within the shooting range, the arranger 360 arranges the marker object based on the depth position of that object. On the other hand, in the event the object is not within the shooting range, the arranger 360 arranges the marker object based on a different position from the depth position of that object, which is, for example, the position of the frontmost part or rearmost part of the shooting range.

To be more specific, similar to FIG. 14A described above, in the event the depth position of the specified object Oja is far beyond the shooting range Rn, the arranger 360 arranges the marker object at a depth position Zb of the rearmost part of the shooting range Rn.

On the other hand, as illustrated in FIG. 14B, in the event the depth position of the specified object Oja exists at the near side of the shooting range Rn (i.e. too close to the player), the arranger 360 arranges the marker object at the depth position Zf of the frontmost part of the shooting range Rn. When this takes place, the arranger 360 enlarges the marker image object based on the difference between the depth position of the object Oja and the depth position Zf. That is to say, the arranger 360 functions as a changer and changes the shape of the marker object.

Then, the display controller 170 controls the display of stereoscopic game images as in FIGS. 15A and 15C described above, based on these game images and marker image.

That is to say, in the event the depth position of the object Oja is far beyond the shooting range Rn, the display controller 170 similarly controls the display of the stereoscopic game image illustrated in FIG. 15A. In this case, also, it is possible to let the player know that the object Oja is outside the shooting range (far beyond the shooting range) of the weapon equipped.

On the other hand, in the event the depth position of the object Oja represents near side of the shooting range Rn, the display controller 170 similarly controls the display of the stereoscopic game image illustrated in FIG. 15C. In this case, also, it is possible to let the player know that the object Oja is present outside the shooting range (near side of the shooting range) of the weapon equipped.

Note that, although in the above variation the range of depth (the shooting range, for example) has been set depending on the weapon equipped by the player character, it is equally possible to set the range of depth depending on the characteristics of the player character. For example, the range of depth may be set depending on the player character's ability point, experience point and so on.

To explain this in more detail, in the event the player character is a character of great long-distance attack ability, depending on this ability point, a range of depth based on a distant position from the viewpoint is set. On the other hand, in the event the player character is a character of great short-distance attack ability, depending on this ability point, a range of depth based on a close position from the viewpoint is set.

In this way, by setting the range of depth depending on the player character's characteristics, even when the player is operating the character of great long-distance attack ability, even if the object located somewhat far from the viewpoint is specified, that object is within the range of depth. That is to say, the marker image is synthesized or the marker object is arranged based on the depth position of the specified object, so that the focus is placed on both the object and the marker, and neither looks blurred in double. On the other hand, in the event the player is operating the character of great short-distance attack ability, even if the object located somewhat close to the viewpoint is specified, that object is excluded from the range of depth. That is to say, since the marker image is synthesized or the marker object is arranged based on a different position from the depth position of the specified object, the focus is placed on only one and blurred double vision is produced. That is to say, depending on whether or not the specified object looks blurred in double, it is possible to indicate the character's characteristics to the player.

Note that it is equally possible to expand a corresponding range of depth in accordance with the growth of the player character (for example, increases of the ability points, the experience points, etc.) over the progression of a game.

Also, in the above-described first and second embodiments, the marker image is synthesized or the marker object is arranged based on the depth position of the specified object, even if the marker in the same size is used, if the depth position to be arranged or synthesized changes, the size of the marker seen from the viewpoint might change. Then, by enlarging and/or reducing the size of the marker image or marker object depending on the depth position to be arranged or synthesized, the size of the marker seen from the viewpoint may be changed to look constant.

Furthermore, with the above variations and embodiments, it is equally possible to set a predetermined range of depth, and, in the event the object is present outside this range of depth, to reshape (for example, enlarge, reduce, and so on) the marker image or marker object depending on the distance from the frontmost part or rearmost part of the range of depth.

To be more specific, in the event this specified object is present in front of the predetermined range of depth, it is possible to enlarge the size of the marker image to be synthesized or the marker object to be arranged, depending on the distance from the frontmost part of that range of depth to the depth position of the specified object. By this means, the marker image is synthesized or the marker object is arranged based on the depth position of the specified object, so that, although the view blurs in double and becomes difficult to see, the size of the marker looks enlarged. Consequently, depending on the marker's size, it is possible to indicate the depth position where the specified object is present.

Note that the reshaping of the marker is not limited to enlargement and reduction, and it is equally possible to change the color, shape and so on. Furthermore, as explained with the above variations, it is possible to set a predetermined range of depth based on the characteristics of the player character or the weapon which the player character possesses.

### Other Embodiments

Although cases have been described above with the first and second embodiments where the present invention is applied to a game device, the present invention is equally applicable to a device other than such game devices.

For example, the present invention is applicable to an image display device that displays objects such as icons and/or the like in stereoscopy and displays images that can be selected using a cursor.

Such an image display device can be realized by configurations nearly the same as the game device 100 of FIG. 4 described above and the game device 300 of FIG. 12 described above.

Note that the image display device may use a cursor instead of a marker, and this cursor may be able to be moved as appropriate, in any directions not only in the line-of-sight direction, in accordance with operations by the user.

To be more specific, the acquirer 120 acquires the depth position of an object such as an icon specified by operations by the user. Then, in the event the same configuration as the game device 100 is employed, the synthesizer 160 synthesizes a cursor image, based on the depth position of the object acquired by the acquirer 120. Also, in the event the same configuration as the game device 300 is employed, the arranger 360 arranges a cursor object, based on the depth position of the object acquired by the acquirer 120. By this means, in the same way as described above, the cursor is displayed in accordance with the depth position of the icon. That is to say, the image display device displays a stereoscopic image that looks as if a cursor were arranged at the depth position of an icon to which the cursor has moved.

Also, this image display device may provide such display that guides a cursor to a specific icon (an object manipulated by the creator).

For example, in the event there is a desire to select a specific icon from a plurality of icons all arranged at different depth positions in a three-dimensional virtual space, the image display device may fixedly display a cursor at the same depth position as that of the icon to be selected.

Also, the above-described predetermined range of depth may be set with respect to a predetermined object alone. That is to say, when the acquirer 120 specifies an object by operations by the player, whether or not that object is the predetermined object is determined. Then, in the event the specified object is the predetermined object, based on the acquired depth position of that object, the synthesizer 160 synthesizes a cursor image (in the event the same configuration as the game device 100 is employed), or the arranger 360 arranges a cursor object (in the event the same configuration as the game device 300 is employed). On the other hand, in the event the specified object is not the predetermined object, based on a different position from the depth position of that object, the synthesizer 160 synthesizes the cursor image, or the arranger 360 arranges the cursor object.

That is to say, only when a move (superimposition) to an icon to be selected is made, the depths of the cursor and the icon are made to be the same. By this means, although a move to a different icon produces a blur, a move to the specific icon clears up that blur, so that it is possible to naturally guide a cursor to an icon desired to be selected.

Also, although the parallax barrier method has been described with the above embodiments as an example, other methods to produce parallax can also be applied as appropriate. For example, it is possible to use lenticular lenses and/or the like, or it is possible to produce parallax using liquid crystal shatter glasses and/or the like.

Also, although cases have been described with the above embodiments where the right eye-use image and the left eye-use image are generated by taking photographs from a plurality of virtual cameras that are spaced apart, the method of generating the right eye-use image and the left eye-use image is by no means limited to this and can be adopted on an arbitrary basis. For example, it is possible to perform data conversion of images photographed from a single virtual camera and generate the right eye-use image and the left eye-use image.

Also, although cases have been described with the above embodiments where a stereoscopic image is displayed utilizing binocular parallax, the method of displaying the stereoscopic image is not limited to this and can be adopted on an arbitrary basis. For example, it is possible to display the stereoscopic image utilizing holograms (holography).

Also, although cases have been described with the above embodiments where a stereoscopic image is displayed in binocular stereoscopy, this binocular stereoscopy is by no means limiting, and it is equally possible to display a stereoscopic image that is easy to view using different stereoscopy including multi-view stereoscopy.

Also, cases have been described with the above embodiments where the image display device of the present invention is applied to the information processing device 1 (for example, a portable game device) including the parallax barrier 19 and the first display 18. That is to say, although cases to display a stereoscopic image on a display in a device have been described, it is equally possible to display the stereoscopic image on an external display (an external display device).

For example, the display controller 170 may control the external display device such that the left eye-use image GL illustrated in FIG. 9A described above is seen only by the player's left eye and also control the external display device such that the right eye-use image GR illustrated in FIG. 9B described above is seen only by the player's right eye.

To be more specific, with reference to the above-described FIG. 3 as an example, the parallax barrier 19 is also arranged in front of the display 18 (first display 18) in the external display device. Then, the display controller 170 controls the parallax barrier 19 and/or the like such that light beams from different pixels enter the player's left eye Le than enter the right eye Re via the slits St. That is to say, the display controller 170 controls the external display device such that only light beams from the left eye-use pixels LCD-L are radiated on the left eye Le and also controls the external display device such that only light beams from the right eye-use pixels LCD-R are radiated on the left eye Re.

Note that, upon controlling the external display device, the display controller 170 may control the external display device via cable or wireless communication.

Having described and illustrated the principles of this application by reference to one or more preferred embodiments, it should be apparent that the preferred embodiments may be modified in arrangement and detail without departing from the principles disclosed herein and that it is intended that the application be construed as including all such modifications and variations insofar as they come within the spirit and scope of the subject matter disclosed herein.

What is claimed is:

1. A device that displays an image to view various objects arranged in a three-dimensional virtual space from a viewpoint in the three-dimensional virtual space in a way to allow stereoscopy, the device comprising:
an acquirer that acquires depth information of an object specified by an operation by a player;
a generator that generates a plurality of images based on the viewpoint;
a synthesizer that synthesizes a marker image to represent a sight in each generated image based on the acquired depth information of the object; and
a display controller that controls display of a stereoscopic image based on each image in which the marker image is synthesized.

2. The device according to claim 1, wherein the synthesizer synthesizes the marker image to represent the sight in each generated image, based on the acquired depth information of the object, only when the depth information of the object acquired by the acquirer is within a predetermined range of depth.

3. The device according to claim 1, further comprising a changer that changes a shape of the marker image, when the depth information of the object acquired by the acquirer is outside a predetermined range of depth.

4. The device according to claim 1, wherein a range of depth is set with different ranges depending on characteristics of a character operated by the player or an item that the character possesses.

5. A device that displays an image to view various objects arranged in a three-dimensional virtual space from a viewpoint in the three-dimensional virtual space in a way to allow stereoscopy, the device comprising:
an acquirer that acquires depth information of an object specified by an operation by a player;
an arranger that arranges a marker object to represent a sight, based on the acquired depth information of the object;
a generator that generates a plurality of images in which objects in view, including the marker object, are arranged based on the viewpoint; and
a display controller that controls display of a stereoscopic image, based on each generated image.

6. The device according to claim 5, wherein the arranger synthesizes the marker image to represent the sight based on the acquired depth information of the object, only when the depth information of the object acquired by the acquirer is within a predetermined range of depth.

7. The device according to claim 5, further comprising a changer that changes a shape of the marker object, when the depth information of the object acquired by the acquirer is outside the predetermined range of depth.

8. The device according to claim 5, wherein the range of depth is set with different ranges depending on characteristics of a character operated by the player or an item that the character possesses.

9. An image display device that displays an image to view a three-dimensional virtual space in which objects are arranged from a predetermined viewpoint in a way to allow stereoscopy, the image display device comprising:
an acquirer that acquires depth information of an object specified by an operation by a player;
a generator that generates a plurality of images in which a predetermined additional object is arranged based on the depth information of the object acquired by the acquirer, based on the viewpoint; and
a display controller that controls display of a stereoscopic image based on each generated image.

10. A stereoscopic image display method in an image display device that comprises an acquirer, a generator and a display controller, and that displays an image to view a three-dimensional virtual space in which objects are arranged from a predetermined viewpoint in a way to allow stereoscopy, the stereoscopic image display method comprising:
an acquisition step of acquiring, by the acquirer, depth information of an object specified by an operation by a player;
a generation step of generating, by the generator, a plurality of images, in which a predetermined additional object is arranged based on the depth information of the object acquired in the acquisition step, based on the viewpoint; and
a display control step of controlling, by the display controller, display of a stereoscopic image based on each generated image.

11. A computer readable non-transitory recording medium storing a program, the program causing a computer, which displays an image to view a three-dimensional virtual space in which objects are arranged from a predetermined viewpoint in a way to allow stereoscopy, to function as:
an acquirer that acquires depth information of an object specified by an operation by a player;
a generator that generates a plurality of images, in which a predetermined additional object is arranged based on the depth information of the object acquired by the acquirer, based on the viewpoint; and
a display controller that controls display of a stereoscopic image based on each generated image.
